(19) United States
(12) Patent Application Publication
(10) Pub. No.: US 2026/0341681 A1
(43) Pub. Date: Oct. 29, 2026

(54) SILICON-BASED ANODE MATERIAL, ANODE STRUCTURE FOR LITHIUM-ION BATTERIES, AND LITHIUM-ION BATTERY

(71) Applicant: GIGA SOLAR MATERIALS CORPORATION, Hukou Township (TW)

(72) Inventors: Ding-Jhou WU, Hukou Township (TW); Ning Lee, Hukou Township (TW); Cheng-Yang Liu, Hukou Township (TW)

(73) Assignee: GIGA SOLAR MATERIALS CORPORATION, Hukou Township (TW)

(21) Appl. No.: 19/467,440

(22) Filed: Feb. 2, 2026

(30) Foreign Application Priority Data
Apr. 24, 2025 (TW) 114115468

(51) Int. Cl. H01M 4/36; H01M 4/02; H01M 4/133; H01M 4/1393; H01M 4/48; H01M 4/587; H01M 4/62; H01M 10/0525; H01M 10/42

(52) U.S. Cl. CPC H01M 4/366; H01M 4/133; H01M 4/1393; H01M 4/364; H01M 4/483; H01M 4/587; H01M 4/62; H01M 10/0525; H01M 10/4235; H01M 2004/027

(57) ABSTRACT

A silicon-based anode material, an anode structure for lithium-ion batteries, and a lithium-ion battery are provided. The silicon-based anode material includes a non-metal-doped silicon carbon particle and a metal-doped carbon coating layer. The silicon carbon particle is composed of a mixture of SiOₓ and carbon, wherein 0=x<1, and a surface thereof is coated with a carbon coating layer doped with metal elements. The metal-doped carbon coating layer can effectively protect the silicon carbon particle and improve the high-temperature cycle life of the silicon-based anode material. In addition, metal doping helps improve the conductivity of material, thereby enhancing the fast-charging performance of lithium-ion batteries. The invention can improve the charging and discharging efficiency and stability of the lithium-ion batteries, and is suitable for high-performance battery applications.

### CROSS-REFERENCE TO RELATED APPLICATION

This application claims the priority benefits of Taiwan Patent Application No. 114115468, filed on Apr. 24, 2025. The entirety of each of the above-mentioned patent applications is hereby incorporated by reference herein and made a part of this specification.

### BACKGROUND OF THE INVENTION

### Field of the Invention

The invention relates to the technical field of lithium-ion batteries, in particular, to a silicon-based anode material, an anode structure for lithium-ion batteries, and a lithium-ion battery.

### Description of the Prior Art

With the widespread application of lithium-ion batteries in consumer electronics, electric vehicles, and energy storage systems, the development of high-capacity anode materials has become crucial for improving battery performance. Silicon-based anode materials are considered an ideal choice for next-generation high-energy-density batteries due to their theoretical specific capacity of up to about 4200 mAh/g, far exceeding that of traditional graphite anodes (about 372 mAh/g).

However, the silicon-based anode materials still face many technical challenges. First, silicon undergoes volume expansion of up to 300% or more during insertion and extraction of lithium ions, leading to material structure cracking, electrode delamination, and damage to the conductive network, which in turn affects the cycle life of the battery. Secondly, when silicon surfaces come into contact with electrolytes, side reactions are prone to occur, forming an excessively thick or unstable solid electrolyte interphase (SEI) layer, which leads to irreversible loss of lithium ions, increases internal resistance and reduces coulombic efficiency. In addition, silicon itself has low conductivity, which is not conducive to electron transport and affects the rate performance and fast charging capability of the battery.

In order to solve the above problems, various improvement strategies have been developed in the prior art, such as using carbon materials to coat silicon particles to improve conductivity, or introducing nanostructures and porous structures to alleviate volume expansion. However, existing carbon coating technology still faces the problem of uneven coating, which may lead to some silicon surface being exposed, further affecting the stability of the SEI layer and battery life. Therefore, how to achieve a uniform and stable coating structure while improving the conductivity and mechanical stability of the material remains a core issue in the development of silicon-based anode materials.

### BRIEF SUMMARY OF THE INVENTION

In view of the above problems, a main objective of the invention is to provide a silicon-based anode material, an anode structure for lithium-ion batteries, and a lithium-ion battery, so that the metal-doped carbon coating layer effectively improves the cycle life and conductivity of the silicon-based anode material, thereby enhancing the long-term performance and power characteristics of lithium-ion batteries.

To achieve the above objective, the invention provides a silicon-based anode material, which includes a non-metal-doped silicon carbon particle and a metal-doped carbon coating layer. The silicon carbon particle has a composition of a mixture of SiOₓ and carbon, wherein 0≤x<1; the metal-doped carbon coating layer is coated onto a surface of the silicon carbon particle, wherein a metal element doped in the carbon coating layer being one or more of aluminum, titanium, nickel, tin, copper, manganese, chromium and cobalt.

According to an embodiment of the invention, a median particle size (D50) of the silicon carbon particle is between 1 and 15 micrometers.

According to an embodiment of the invention, in a range of depths less than 5 nanometers, a ratio of a metal atomic ratio to a carbon atomic ratio in the carbon coating layer is greater than 2.0%.

On the other hand, the invention further provides a lithium-ion battery anode structure, which includes the above silicon-based anode material, and an adhesive, a conductive agent and copper foil, wherein the silicon-based anode material, the adhesive, and the conductive agent are uniformly mixed to form a slurry, which is then coated onto a surface of the copper foil and dried and compacted to form a stable anode material layer.

Still further, the invention provides a lithium-ion battery, which includes a cathode, an anode, a separator film, and an electrolyte, wherein the anode adopts the above lithium-ion battery anode structure, the cathode and the anode are respectively disposed inside the lithium-ion battery and separated from each other by the separator film, and the electrolyte is immersed among the cathode, the anode and the separator film.

Compared with prior art, the silicon-based anode material and an application thereof in lithium-ion batteries provided by the invention may effectively protect the silicon-based anode material by utilizing the metal-doped carbon coating layer, reduce the volume expansion of carbon silicon particles, and improve conductivity and stability. The design of doping metal in the carbon coating layer may avoid direct contact between silicon carbon particles and electrolyte, thereby reducing unnecessary SEI layer formation and improving cycle life. The invention may improve the stability of batteries under high temperature conditions and enhance fast charging performance, thereby improving the long-term performance of lithium-ion batteries.

The following detailed description is further made by the inventor through specific embodiments in conjunction with the attached drawings, so that the purpose, technical content, characteristics and effects achieved by the invention can be more easily understood.

### BRIEF DESCRIPTION OF THE DRAWINGS

FIG. 1 is a diagram of a silicon-based anode material provided by an embodiment of the invention.

FIG. 2 is a diagram of an anode structure of a lithium-ion battery provided by an embodiment of the invention.

FIG. 3 is a diagram of the lithium-ion battery provided by an embodiment of the invention.

FIG. 4 shows the Al 2p spectra of the silicon-based anode material of an embodiment and a comparative example of the invention, obtained by surface XPS analysis.

FIG. 5 shows the C 2p spectra of the silicon-based anode material of the embodiment and the comparative example of the invention, obtained by surface XPS analysis.

FIG. 6 shows the relationship between discharge capacity retention and cycle life of the lithium-ion battery in the embodiment and the comparative example of the invention.

### DETAILED DESCRIPTION OF THE INVENTION

The technical solutions used in the embodiments of the invention are for the purpose of more clearly illustrating the technical solutions of the invention, and are therefore only examples. Unless otherwise specified, they should not be used to limit the scope of protection of the invention. In order to give the reader a more complete understanding of the invention, many specific details are provided in the description of the specification; however, the invention may still be practiced even if some or all of the specific details are omitted. Furthermore, well-known steps or elements are not described in detail to avoid creating unnecessary limitations on the invention. In the case of no conflicts, the embodiments and features in the embodiments of the disclosure can be combined mutually. It should be noted that, unless otherwise specified, all technical and scientific terms used in the invention have the same meaning as commonly understood by those skilled in the art to which the invention pertains.

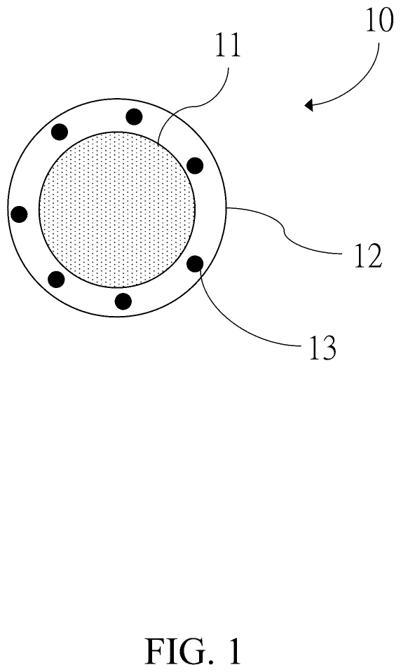

With reference to FIG. 1, a diagram of a silicon-based anode material provided by an embodiment of the invention is shown. The silicon-based anode material 10 of the embodiment includes a non-metal-doped silicon carbon particle 11 and a metal-doped carbon coating layer 12.

The non-metal-doped silicon carbon particle 11, as a core of the silicon-based anode material 10, has a composition of a mixture of SiOₓ and carbon, wherein 0≤x<1. The proportion of SiOₓ in silicon carbon is between 40% and 60%. Further, a median particle size (D50) of the silicon carbon particle 11 is preferably between 1 and 15 micrometers (μm).

The metal-doped carbon coating layer 12 is coated on a surface of the silicon carbon particle 11 to form an outer layer of the silicon-based anode material 10. The carbon coating layer 12 provides uniform coatings to ensure that all silicon carbon particles 11 are uniformly protected by the metal-doped carbon coating layer 12. A metal element 13 doped in the carbon coating layer 12 includes, but is not limited to, one or more of aluminum, titanium, nickel, tin, copper, manganese, chromium and cobalt. Further, within a depth of less than 5 nanometers (nm), a ratio of a metal atomic ratio to a carbon atomic ratio of the carbon coating layer 12 is preferably greater than 2.0%, wherein 2.0% is a lower limit of the ratio within a variable range.

The invention may effectively improve the conductivity of the silicon-based anode material 10 and reduce side reactions caused by direct contact between the silicon carbon particle 11 and an electrolyte through the metal-doped carbon coating layer 12. Meanwhile, the metal-doped carbon coating layer 12 helps to improve electronic conductivity and reduce interface resistance, thereby enhancing fast charging performance and enabling the lithium-ion battery to maintain stable cycle life and high coulombic efficiency under high-rate charge and discharge conditions.

The silicon-based anode material 10 of the invention may be prepared by the following method, which includes the following steps.

First, a silicon bulk material with a purity higher than 99.995% is used as the raw material, with a composition including SiOₓ (0≤x<1) and carbon, and is mechanically ground into a powder with a particle size of less than 150 nanometers. Subsequently, through a granulation process, a silicon carbon particle with a median particle size (D50) between 5 and 10 micrometers is formed. Then, styrene-maleic anhydride with a weight percentage greater than 2% and aluminum nitrate with a weight percentage greater than 0.1% are dissolved in alcohol to prepare a precursor solution. The silicon carbon particle is immersed in the above precursor solution for more than 1 hour to ensure full adsorption; then, under vacuum, the temperature is raised to 800 °C within 1-3 hours, and argon gas (Ar) with a flow rate greater than 30 sccm is introduced; the temperature is then held for more than 1 hour to allow an aluminum-doped carbon coating layer to stably coat the surface of the silicon carbon particle. The final product is the silicon-based anode material of the invention, wherein a thickness of the carbon coating layer is set to 15 nanometers, and a metal doping concentration thereof is ensured to be appropriate.

In the preparation method of the invention, a carbon source used in the carbon coating layer may include, but is not limited to, asphalt, resin, methane, acetylene, citric acid, maleic anhydride, etc.; the carbon coating process may include, but are not limited to, solid-phase reactive coating, liquid-phase reactive coating, chemical vapor deposition (CVD), etc.; the metal doping process for the carbon coating layer includes, but are not limited to, solid-phase chemical reactions, liquid-phase chemical reactions, chemical vapor deposition, and chemical vapor reaction (CVR). Furthermore, there are no restrictions on the metal precursor used in the metal doping process of the carbon coating layer. The metal elements doped in the product may include, but are not limited to, aluminum, titanium, nickel, tin, copper, manganese, chromium, cobalt, etc. The selection of doping elements may be adjusted according to the requirements of conductivity, chemical stability and interface compatibility.

The silicon-based anode material provided by the invention may be applied in the manufacture of an anode structure of the lithium-ion battery and further in the preparation of the lithium-ion battery. The silicon-based anode material utilizes the metal-doped carbon coating layer to effectively improve the cycle life, stability, and conductivity of the silicon-based anode material, and significantly reduce the volume expansion effect of silicon materials caused by lithium intercalation, thereby enhancing the fast charging performance and long-term use efficiency of the lithium-ion battery.

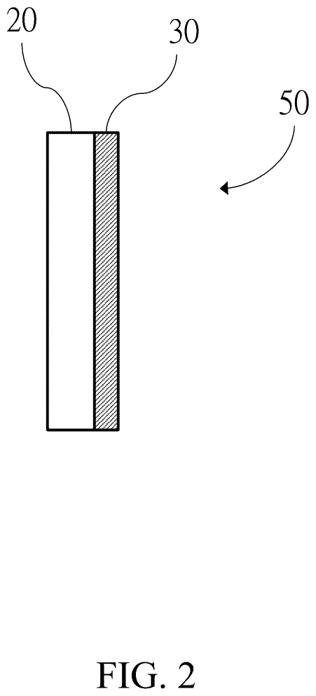

With reference to FIG. 2, a diagram of an anode structure of a lithium-ion battery provided by an embodiment of the invention is shown. The anode structure 50 of the lithium-ion battery of the embodiment includes the above silicon-based anode material 10 (see FIG. 1), an adhesive, a conductive agent (not shown in the figure), and a copper foil 20. The silicon-based anode material 10, the adhesive and the conductive agent are uniformly mixed to form a slurry, which is then uniformly coated on a surface of the copper foil 20. After drying and compaction, an anode material layer 30 with good mechanical strength and electrical conductivity may be formed, further improving the overall performance of the lithium-ion battery.

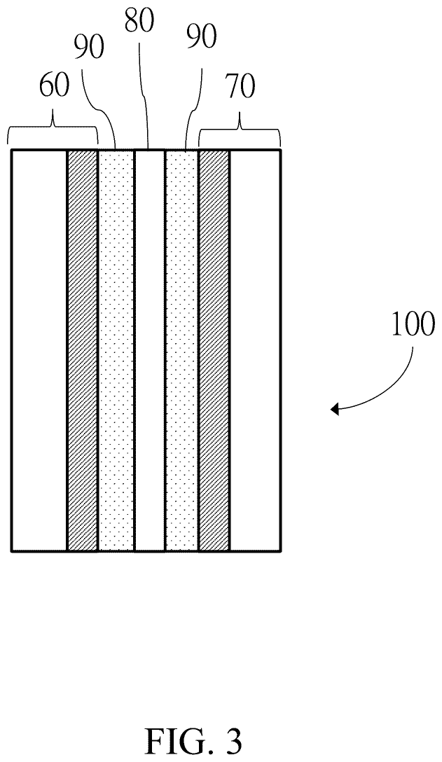

With reference to FIG. 3, a diagram of the lithium-ion battery provided by an embodiment of the invention is shown. The lithium-ion battery 100 of the embodiment includes a cathode 60, an anode 70, a separator film 80 and an electrolyte 90. The anode 70 adopts the above anode structure 50 of the lithium-ion battery (see FIG. 2) and is disposed inside the lithium-ion battery 100 opposite to the cathode 60. The two are separated by a separator film 80 to prevent short circuit. Further, the electrolyte 90 permeates between the cathode 60, the anode 70, and the separator film 80, ensuring that lithium ions may migrate smoothly during charging and discharging to maintain stable electrochemical reactions and excellent charging and discharging efficiency.

Then, the silicon-based anode material and the lithium-ion battery of the invention are analyzed and compared through several experimental methods and comparative examples to verify the technical effects achieved by the invention.

### (1) XPS Surface Analysis of Silicon-Based Anode Material

The silicon-based anode materials in the embodiments and comparative examples of the invention all have a structure in which the silicon carbon particle is coated with a carbon coating layer, wherein the silicon carbon particle contains SiOₓ (0≤x<1) and carbon, and the median particle size (D50) is between 1 and 15 μm. The main difference is that the carbon coating layer in the embodiments of the invention is doped with metal elements, while the carbon coating layer in the comparative examples is not doped with metal elements. To perform surface analysis, XPS (X-ray Photoelectron Spectroscopy) technology is used to excite aluminum Kα monochromatic X-ray source to measure the surface elemental composition and bonding state of the samples in the embodiments and comparative examples of the invention. Analysis results show that the surface of the embodiments of the invention mainly contains elements such as carbon, aluminum, oxygen and silicon. The characteristic peak intensities of each element are defined as follows:
Carbon: Total intensity of photoelectron signals within the electron binding energy range of 278-290 eV;
Aluminum: Total intensity of photoelectron signals within the electron binding energy range of 65-80 eV;
Oxygen: Total intensity of photoelectron signals within the electron binding energy range of 524-540 eV;
Silicon: Total intensity of photoelectron signals within the electron binding energy range of 94-110 eV.

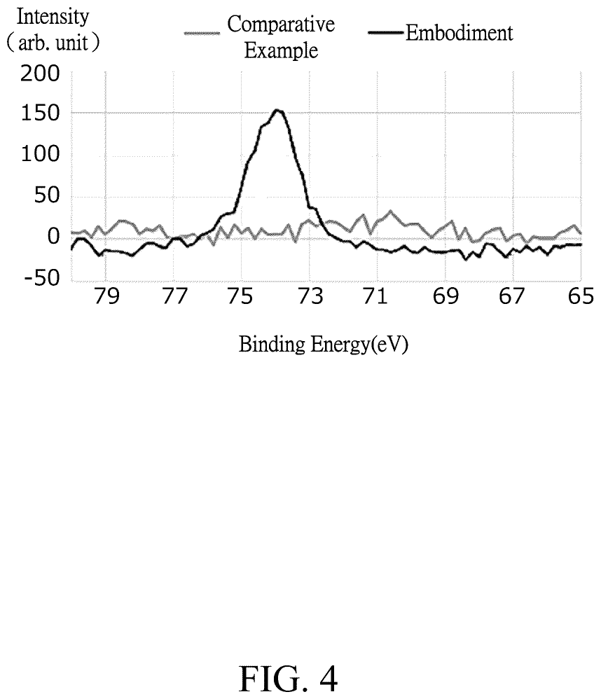

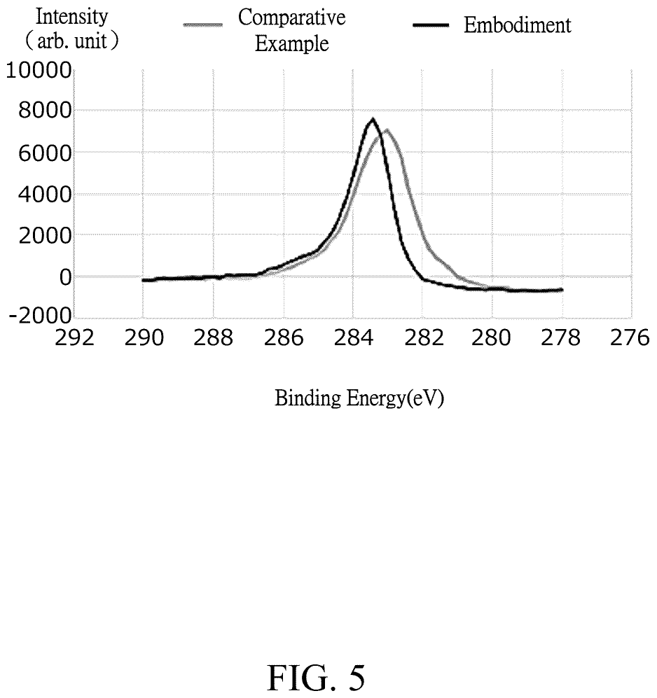

With reference to FIGS. 4 and 5, FIG. 4 shows the Al 2p spectra of the silicon-based anode material of an embodiment and a comparative example of the invention, obtained by surface XPS analysis; FIG. 5 shows the C 2p spectra of the silicon-based anode material of the embodiment and the comparative example of the invention, obtained by surface XPS analysis.

In addition, to further quantify the content of each element, the intensity of the characteristic peaks is corrected using the corresponding relative sensitivity factor (RSF). Calculation method:

Atomic ratios of carbon and aluminum-respective characteristic peak intensities/sum of characteristic peak intensities of all elements.

The results show that in the embodiments of the invention, the atomic ratio of aluminum is greater than 2.0% of the atomic ratio of carbon, confirming that metal doping does exist and may affect the electrochemical properties of the material.

### (2) Analysis on Electrochemical Characteristics of Lithium-Ion Batteries

The lithium-ion batteries in the embodiments and comparative examples of the invention are prepared according to a general process. A cathode active material is lithium nickel cobalt manganese oxide (NCM), a cathode current collector is an aluminum foil, and polyvinylidene fluoride (PVDF) is used as a cathode adhesive to attach the cathode active material to the cathode current collector. An anode active material is the silicon-based anode material, which is a mixture of graphite and silicon powder, with silicon powder accounting for 15%. The anode current collector is a copper foil, and sodium carboxymethyl cellulose (CMC) and styrene-butadiene rubber (SBR) are used as an anode adhesive to uniformly attach the anode active material to a surface of the anode current collector. The cathode and the anode are separated inside the battery by the separator film. The main difference between the silicon-based anode materials of the embodiments of the invention and the comparative examples is that the carbon coating layer of the invention undergoes a metal doping coating process, while the carbon coating layer of the comparative example does not undergo a metal doping coating process. The battery is assembled in a pouch cell form, and the electrolyte contains a lithium salt, a solvent and an additive. The lithium salt is LiPF₆; the solvent includes ethylene carbonate (EC), diethyl carbonate (DEC), and ethyl methyl carbonate (EMC), with each solvent accounting for 10% to 50% by mass; the additive includes fluoroethylene carbonate (FEC), vinylene carbonate (VC), and propylene carbonate (PC). The battery undergoes standard processes including electrolyte injection, immersion, formation, capacity testing, aging, and secondary sealing. The formation conditions involve pre-cycling at a charge-discharge rate of 0.1 C within a voltage range of 2.8V and 4.25V to form a solid electrolyte interphase (SEI) film. After pre-cycling, the pouch cell is tested for direct current internal resistance at room temperature in accordance with IEC 61960-2330 standard. Finally, the pouch cell is placed in a high-temperature oven at 45 degrees Celsius and cycled at a charge-discharge rate of 1 C within a voltage range of 2.8 to 4.25V, and the discharge capacity of each cycle is recorded.

The direct current internal resistance is determined in accordance with the IEC 61960-2330 standard. The pouch cell is discharged at 0.2 C for 10 seconds with a state of charge of 50%, and an instantaneous voltage V1 and a current I1 are recorded; then the pouch cell is discharged at 1 C for 1 second, and an instantaneous voltage V2 and a current I2 are recorded. The formula for calculating the direct current internal resistance is (V1−V2)/(I2−I1).

Table 1 lists the direct current internal resistance of the embodiments of the invention and the comparative examples.

TABLE 1

| | | Comparative |
|---|---|---|
| | Embodiment | Example |
| Direct Current | 217.5 | 282.8 |
| Internal Resistance | | |
| (mOhm) | | |

Analysis results show that the metal-doped carbon coating layer of the invention may effectively reduce the direct current resistance of the anode and enhance the electron transport capability. Therefore, the power performance of the lithium-ion battery may be significantly improved, such as fast charging efficiency.

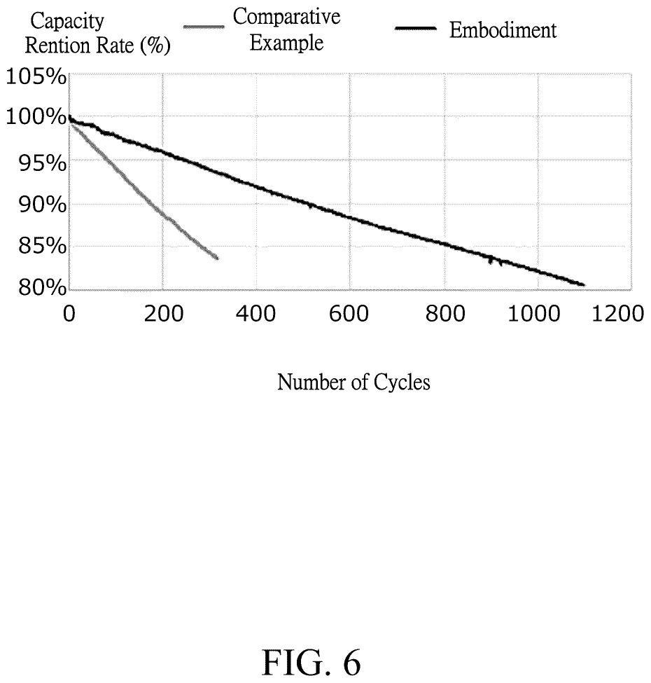

With reference to FIG. 6, the relationship between discharge capacity and cycle life of the lithium-ion battery at 45 degrees Celsius in the embodiment and the comparative example of the invention is shown. Analysis results show that the metal-doped carbon coating layer of the invention may effectively suppress the excessive SEI formation on the silicon surface, and, especially under high temperature conditions, may significantly improve the cycle life of the battery and improve the long-term stability and performance of the lithium-ion battery.

In summary, the silicon-based anode material provided by the invention is provided with a metal-doped carbon coating layer, which may significantly improve the overall performance of the lithium-ion battery. The core of the silicon-based anode material is the silicon carbon particle, with an outer layer coated with the metal-doped carbon layer. This design improves conductivity and stability, while effectively suppressing the volume expansion of the silicon-based material during charging and discharging, thereby extending the lifespan of the lithium-ion battery. The metal-doped carbon coating layer is used to improve the performance of the lithium-ion battery.

The silicon-based anode material of the invention may be applied to the anode structure of the lithium-ion battery, and further improves the fast charging performance and long-term use efficiency of the lithium-ion battery. Compared with traditional silicon-based materials, the addition of the metal-doped carbon coating layer gives the material higher stability, especially at high temperatures, thereby effectively preventing the formation of excessive SEI film and thus improving the cycle life of the lithium-ion battery.

After a series of experimental analyses and comparisons, the results show that the silicon-based anode material of the invention exhibits superior cycle life under high-temperature conditions, demonstrating a potential for widespread application in the lithium-ion battery. The technological breakthrough in the silicon-based anode material provides an effective solution for improving the performance of the lithium-ion battery, and has significant technical implications for enhancing fast-charging capabilities, stability and long-term performance of the battery.

Although the invention has been described in detail through the above preferred embodiments, it should be understood that the above description should not be considered as a limitation of the invention. After reading the above, those skilled in the art will find that various modifications and substitutions to the invention will be readily apparent. Therefore, the scope of protection of the invention should be defined by the appended claims.

What is claimed is:

1. A silicon-based anode material, comprising:
a non-metal-doped silicon carbon particle, composed of a mixture of SiOₓ and carbon, where 0≤x<1; and
a metal-doped carbon coating layer, coated onto a surface of the silicon carbon particle, wherein a metal element doped in the carbon coating layer being one or more of aluminum, titanium, nickel, tin, copper, manganese, chromium and cobalt.

2. The silicon-based anode material according to claim 1, wherein a median particle size (D50) of the silicon carbon particle is between 1 and micrometers.

3. The silicon-based anode material according to claim 1, wherein in a range of depths less than 5 nanometers, a ratio of a metal atomic ratio to a carbon atomic ratio in the carbon coating layer is greater than 2.0%.

4. A lithium-ion battery anode structure, comprising a silicon-based anode material, an adhesive, a conductive agent, and a copper foil, wherein the silicon-based anode material, the adhesive, and the conductive agent are uniformly mixed to form a slurry, which is then coated onto a surface of the copper foil and dried and compacted to form a stable anode material layer,
wherein the silicon-based anode material comprises:
a non-metal-doped silicon carbon particle, composed of a mixture of SiOₓ and carbon, where 0≤x<1; and
a metal-doped carbon coating layer, coated onto a surface of the silicon carbon particle, wherein a metal element doped in the carbon coating layer being one or more of aluminum, titanium, nickel, tin, copper, manganese, chromium and cobalt.

5. The lithium-ion battery anode structure according to claim 4, wherein a median particle size (D50) of the silicon carbon particle is between 1 and 15 micrometers.

6. The lithium-ion battery anode structure according to claim 4, wherein in a range of depths less than 5 nanometers, a ratio of a metal atomic ratio to a carbon atomic ratio in the carbon coating layer is greater than 2.0%.

7. A lithium-ion battery, comprising a cathode, an anode, a separator film, and an electrolyte, wherein the anode adopts the lithium-ion battery anode structure according to claim 4, the cathode and the anode are respectively disposed inside the lithium-ion battery and separated from each other by the separator film, and the electrolyte is immersed among the cathode, the anode and the separator film.
